(19) United States
(12) Patent Application Publication
(10) Pub. No.: US 2019/0233588 A1
(43) Pub. Date: Aug. 1, 2019

(54) LIQUID CRYSTAL CELL, LIQUID CRYSTAL DISPLAY DEVICE, AND METHOD OF PRODUCING LIQUID CRYSTAL CELL

(71) Applicant: SHARP KABUSHIKI KAISHA, Sakai City, Osaka (JP)

(72) Inventors: MASANOBU MIZUSAKI, Sakai City (JP); KOHSHIROH TANIIKE, Sakai City (JP); HIROSHI TSUCHIYA, Sakai City (JP); JUMPEI TAKAHASHI, Sakai City (JP)

(73) Assignee: SHARP KABUSHIKI KAISHA, Sakai City, Osaka (JP)

(21) Appl. No.: 16/311,535

(22) PCT Filed: Jun. 16, 2017
(86) PCT No.: PCT/JP2017/022256

§ 371 Date: Dec. 19, 2018

(30) Foreign Application Priority Data
Jun. 24, 2016 (JP) 2016-125218

(51) Int. Cl. C08G 73/10; G02F 1/1337

(52) U.S. Cl. CPC C08G 73/10; G02F 1/133711

(57) ABSTRACT

A liquid crystal cell according to the present invention includes two substrates facing each other and a liquid crystal layer between the substrates. The substrates have a photo-alignment film on at least one of opposing surfaces of the substrates. The photo-alignment film includes a polymer having a polyamic acid as a main chain. The polyamic acid is obtained through polymerization of a tetracarboxylic dianhydride having a bent structure and a diamine compound having an azobenzene group. The liquid crystal layer includes a first liquid crystal compound having an unsaturated bond and a second liquid crystal compound having at least one structure selected from the group consisting of structures represented by the following chemical formulas (1-1) and (1-2) and has a nematic-isotropic phase transition temperature of 90° C. or more.

(Formula 1-1) and (Formula 1-2)

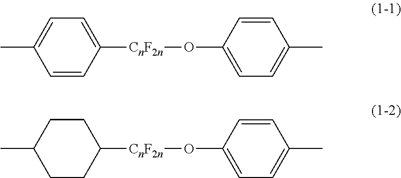

### TECHNICAL FIELD

The present invention relates to a liquid crystal cell, a liquid crystal display device, and a method of producing a liquid crystal cell.

### BACKGROUND ART

A liquid crystal display device includes a liquid crystal panel as a display that displays information such as an image. The liquid crystal panel mainly includes a liquid crystal cell, which includes two substrates and a liquid crystal layer sealed therebetween, and two polarizing plates bonded to both surfaces of the liquid crystal cell. The alignment of the liquid crystal compounds in the liquid crystal layer is controlled by an electric field applied to the liquid crystal layer to regulate the amount of light passing through the liquid crystal panel.

The two substrates included in the liquid crystal panel (liquid crystal cell) each have an alignment film on a surface that is in contact with the liquid crystal layer. In some case, the alignment film (photo-alignment film) includes a polyamic acid as a base. The polyamic acid includes a photo-functional group such as an azobenzene group in the polymer main chain (for example, Patent Document 1).

A known example of the liquid crystal compound used in the liquid crystal panel (liquid crystal cell) includes a highly responsive liquid crystal compound having an alkenyl group having an unsaturated bond, for example. Such a liquid crystal compound is disclosed in Patent Document 2.

### RELATED ART DOCUMENT

### Patent Document

Patent Document 1: Japanese Unexamined Patent Application Publication No. 2009-173792

Patent Document 2: Japanese Unexamined Patent Application Publication No. 2012-7168

### Problem to be Solved by the Invention

The liquid crystal panel including the above-described photo-alignment film as an alignment film and the liquid crystal layer including the above-described liquid crystal compound having the unsaturated bond decreases in a voltage holding rate and increases in residual DC with time in some cases. If the voltage holding rate of the liquid crystal panel decreases, for example, proper alignment control of the liquid crystal compound would be impossible, leading to display defects such as stains and unevenness (image sticking on the liquid crystal panel).

In this type of liquid crystal panel, radicals may be stably present in the liquid crystal layer. The radicals act on the liquid crystal compound in the liquid crystal layer. This probably generates an ionic compound (conductive martial), which is responsible for the decrease in the voltage holding rate.

The main source of the radicals in the liquid crystal layer may be a polyamic acid having a photo-functional group, which is included in the photo-alignment film. This type of photo-alignment film is irradiated with polarized ultraviolet light for a photo-alignment process in the process of producing the liquid crystal panel. When the photo-alignment film is irradiated with predetermined polarized ultraviolet light, azobenzene groups in the photo-alignment film typically undergo photoisomerization reaction (cis-trans isomerization) and the azobenzene groups are aligned in one direction (direction not allowing absorption of the polarized ultraviolet light) at the end. However, in some of the polymers in the photo-alignment film, the azobenzene group in the main chain restricts steric movement and the photoisomerization reaction hardly occurs. In addition, because the photo-alignment film is in a solid form, the steric movement is readily restricted. In particular, if the polymer in the photo-alignment film has a large weight average molecular weight (for example, 10,000 or more), the photoisomerization reaction hardly occurs. At the portion where the photoisomerization reaction hardly occurs, instead of the photoisomerization reaction, the azobenzene group undergoes cleavage such that a nitrogen molecule dissociates to generate a radical. This radical generation reaction occurs not only when the photo-alignment film is irradiated with polarized ultraviolet light in the photo-alignment process but also when the photo-alignment film receives the light from the backlight of the in-use liquid crystal display device.

The radicals generated by the azobenzene groups are possibly transferred to the alkenyl group of the liquid crystal compound, for example. Thus, as described above, the radicals are stably present in the liquid crystal layer to some extent.

The liquid crystal material preferably has a low viscosity in view of the high-speed response properties, for example. However, the liquid crystal compound having a low viscosity, particularly the liquid crystal compound having positive dielectric anisotropy readily allows the radical transfer to the alkenyl group.

Furthermore, if the liquid crystal material has a low nematic-isotropic phase transition temperature (for example, 70 to 85° C.), the viscosity of the liquid crystal layer is lowered when the liquid crystal panel is warmed by the light from the backlight, allowing the radicals to readily transfer to the liquid crystal compound having an alkenyl group.

### DISCLOSURE OF THE PRESENT INVENTION

An object of the invention is to provide a liquid crystal cell that is less likely to decrease in a voltage holding rate, for example.

### Means for Solving the Problem

A liquid crystal cell according to the present invention includes two substrates facing each other and a liquid crystal layer between the substrates. The substrates have a photo-alignment film on at least one of opposing surfaces of the substrates. The photo-alignment film includes a polymer having a polyamic acid as a main chain. The polyamic acid is obtained through polymerization of a tetracarboxylic dianhydride having a bent structure and a diamine compound having an azobenzene group. The liquid crystal layer includes a first liquid crystal compound having an unsaturated bond and a second liquid crystal compound having at least one structure selected from the group consisting of structures represented by the following chemical formulas (1-1) and (1-2). The liquid crystal layer has a nematic-isotropic phase transition temperature of 90° C or more.

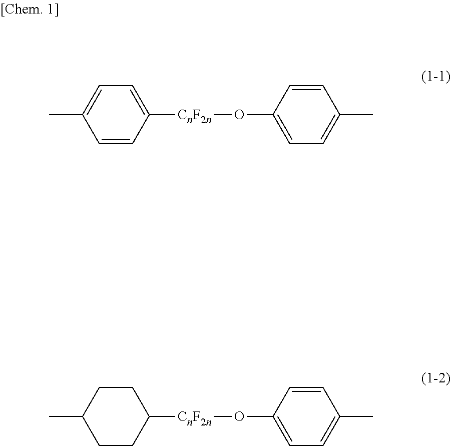

In the formulas, n is an integer of 1 to 3.

In the liquid crystal cell, the second liquid crystal compound is preferably at least one compound selected from the group consisting of compounds represented by the following chemical formulas (2-1) to (2-8).

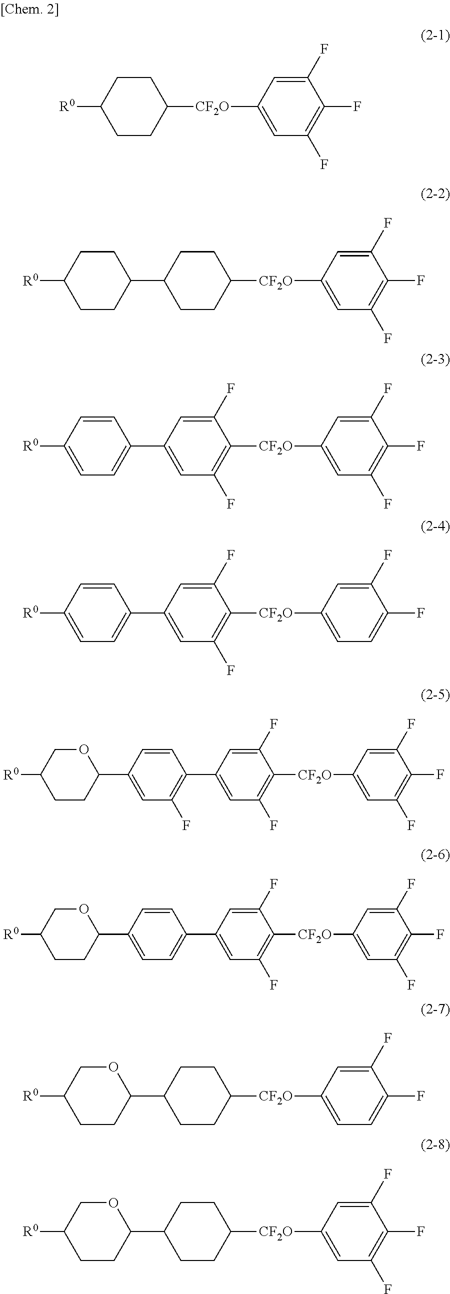

In the formulas, R⁰ is an unsaturated alkyl group having 1 to 12 carbon atom(s).

In the liquid crystal cell, the first liquid crystal compound is preferably at least one compound selected from the group consisting of compounds having an alkenyl group and represented by the following chemical formulas (3-1) to (3-4).

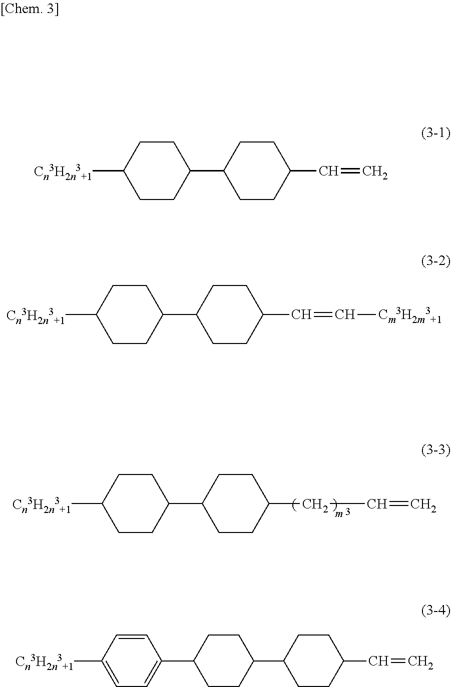

In the formulas, n³ and m³ are identical or different integers and are each an integer of 1 to 6.

In the liquid crystal cell, the tetracarboxylic dianhydride is preferably at least one tetracarboxylic dianhydride selected from the group consisting of tetracarboxylic dianhydrides represented by the following chemical formulas (4-1) to (4-31).

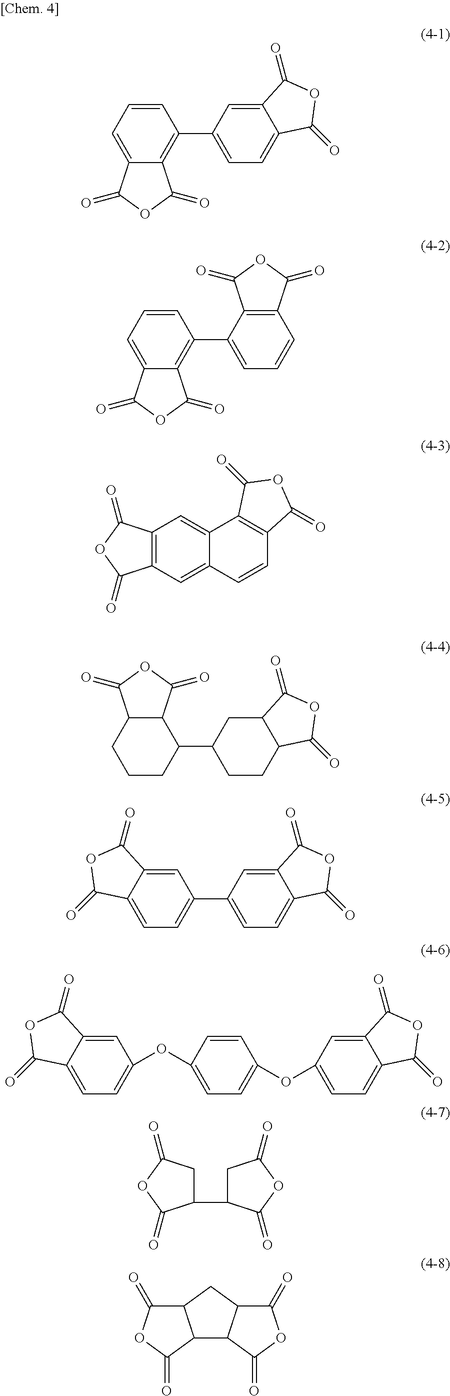

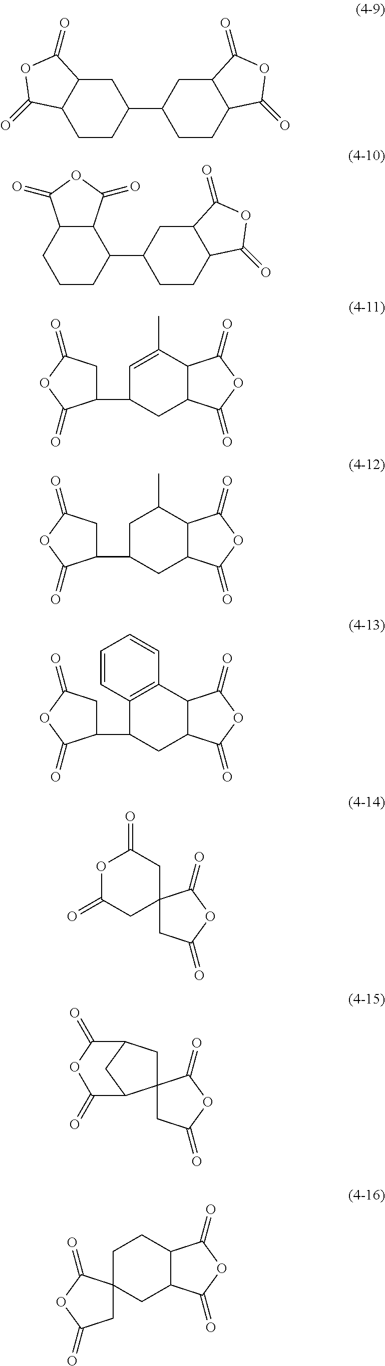

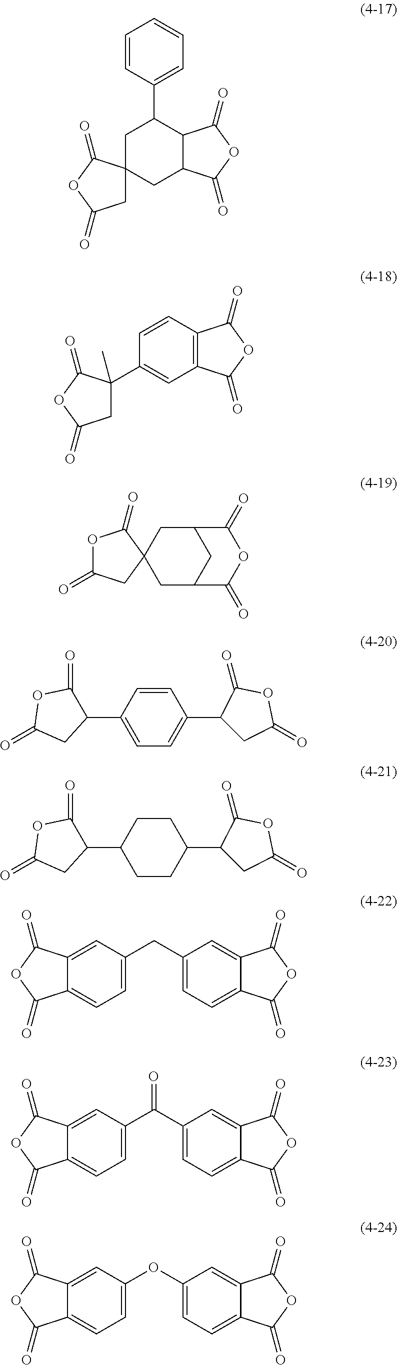

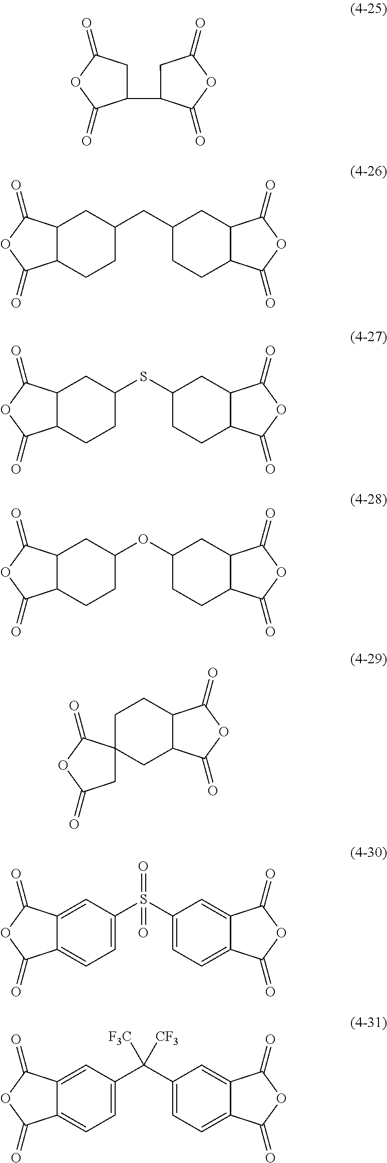

The tetracarboxylic dianhydride is preferably at least one tetracarboxylic dianhydride selected from the group consisting of tetracarboxylic dianhydrides represented by the following chemical formulas (5-1) to (5-4).

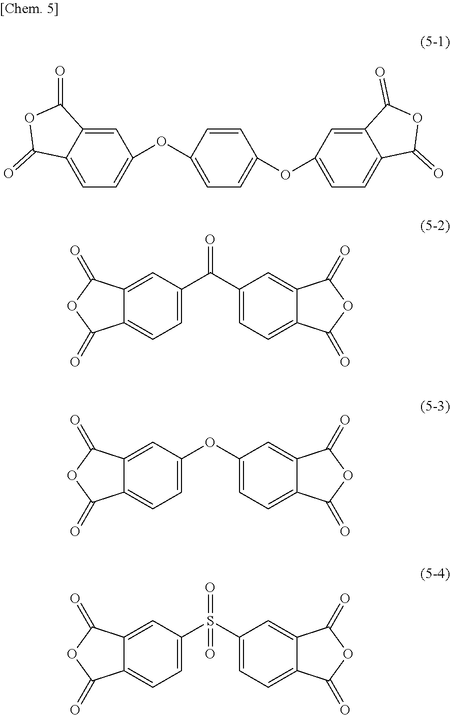 [SMILES: O=C1OC(=O)c2cc(Oc3ccc(Oc4ccc5c(c4)C(=O)OC5=O)cc3)ccc21 ; O=C(c1ccc2c(c1)C(=O)OC2=O)c1ccc2c(c1)C(=O)OC2=O ; O=C1OC(=O)c2cc(Oc3ccc4c(c3)C(=O)OC4=O)ccc21 ; O=C1OC(=O)c2cc(S(=O)(=O)c3ccc4c(c3)C(=O)OC4=O)ccc21]

Furthermore, a liquid crystal display device includes a liquid crystal panel including any one of the above-described liquid crystal cells and a backlight configured to supply light to the liquid crystal panel.

Furthermore, a method of producing a liquid crystal cell according to the present invention is a method of producing any one of the above-described liquid crystal cells. The method includes a coating film formation process, a photo-alignment process, a first firing process, and a second firing process. In the coating film formation process, a photo-alignment agent composition including the polymer is applied onto at least one of the opposing surfaces of the substrates to form a coating film formed of the photo-alignment agent composition on the at least one of the opposing surfaces. In the photo-alignment process, predetermined light is applied to the coating film such that the azobenzene group in the polymer is oriented in a predetermined direction. In the first firing process, the coating film is fired at a first firing temperature after the photo-alignment process. In the second firing process, the coating film is fired at a second firing temperature higher than the first firing temperature after the first firing process.

In the method of producing the liquid crystal cell, the first firing temperature at the first firing process is preferably 175±10°C. and the second firing temperature at the second firing process is preferably 230±10° C.

### Advantageous Effect of the Invention

According to the present invention, a liquid crystal cell that is less likely to decrease in a voltage holding rate, for example, is provided.

### BRIEF DESCRIPTION OF THE DRAWINGS

FIG. 1 is a view schematically illustrating a configuration of a liquid crystal display device according to an embodiment of the invention.

FIG. 2 is a view schematically illustrating a configuration of a liquid crystal cell.

### MODE FOR CARRYING OUT THE INVENTION

(Liquid Crystal Display Device)

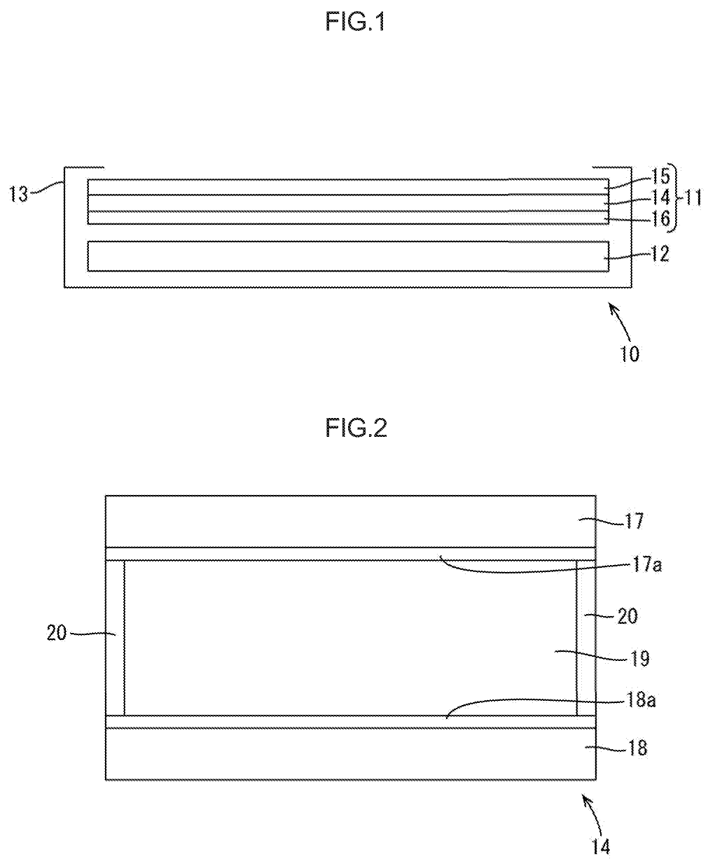

Hereinafter, an embodiment of the invention is described with reference to the drawings. FIG. 1 is a view schematically illustrating a configuration of a liquid crystal display device 10 according to an embodiment of the invention. The liquid crystal display device 10 mainly includes a liquid crystal panel 11 and a backlight 12 configured to supply light to the liquid crystal panel 11. The liquid crystal panel 11 and the backlight 12 are housed in a predetermined housing 13.

The liquid crystal panel 11 mainly includes a liquid crystal cell 14 and two polarizing plates 15 and 16 attached to both surfaces of the liquid crystal cell 14.

(Liquid Crystal Cell)

FIG. 2 is a view schematically illustrating a configuration of a liquid crystal cell. The liquid crystal cell 14 includes two substrates 17 and 18 having photo-alignment films 17a and 18b on opposing surfaces, a liquid crystal layer 19 located between the substrates 17 and 18, and a sealant 20 located between the substrates 17 and 18 and surrounding the liquid crystal layer 19. One of the substrates 17 and 18 is an array substrate 17 and the other is a counter substrate 18.

(Substrates)

The array substrate 17 includes a transparent supporting substrate (for example, formed of glass) and a thin film transistor (TFT), for example, thereon and has the photo-alignment film 17a on a surface (opposing surface) facing the counter substrate 18. The counter substrate 18 includes a transparent supporting substrate (for example, formed of glass) and a color filter (CF), for example, thereon and has the photo-alignment film 18a on a surface (opposing surface) facing the array substrate 17.

When the liquid crystal cell 14 is in a horizontal alignment mode, the array substrate 17 has a counter electrode formed of a transparent conductive film thereon, in addition to a pixel electrode formed of a transparent conductive film, such as ITO. In contrast, when the liquid crystal cell 14 is in a vertical alignment mode, the array substrate 17 has a pixel electrode thereon and the counter substrate 18 has a counter electrode thereon.

(Photo-Alignment Film)

The photo-alignment film includes a polymer film irradiated with polarized light in a photo-alignment process. The polymer film contains a polymer having a polyamic acid represented by the following chemical formula (6) as a main chain. The polyamic acid in the photo-alignment film is a polymer of a tetracarboxylic dianhydride having a bent structure, which is represented by X in the chemical formula (6), and a diamine compound having an azobenzene group, which is represented by Y in the chemical formula (6). The photo-alignment film allows the liquid crystal compound to form a predetermined angle with a polarization direction when subjected to the photo-alignment process.

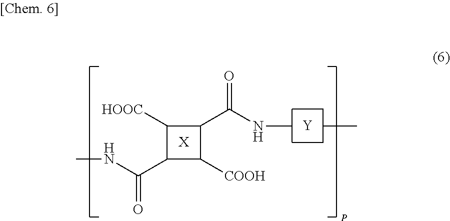

In formula (6), P is a natural number. The tetracarboxylic dianhydride represented by X in formula (6) has a bent structure (bent molecular structure). In this specification, the tetracarboxylic dianhydride having a bent structure may refer to a tetracarboxylic dianhydride that has a functional group having a bent structure between parts corresponding to two carboxylic anhydrides or a tetracarboxylic dianhydride that has a linkage group having a high degree of rotational freedom between parts corresponding to two carboxylic anhydrates and having a bent structure formed between parts corresponding to two carboxylic anhydrides when the linkage group is rotated.

The tetracarboxylic dianhydride having a bent structure, which is represented by X in formula (6), is at least one tetracarboxylic dianhydride selected from the group consisting of the following chemical formulas (4-1) to (4-31).

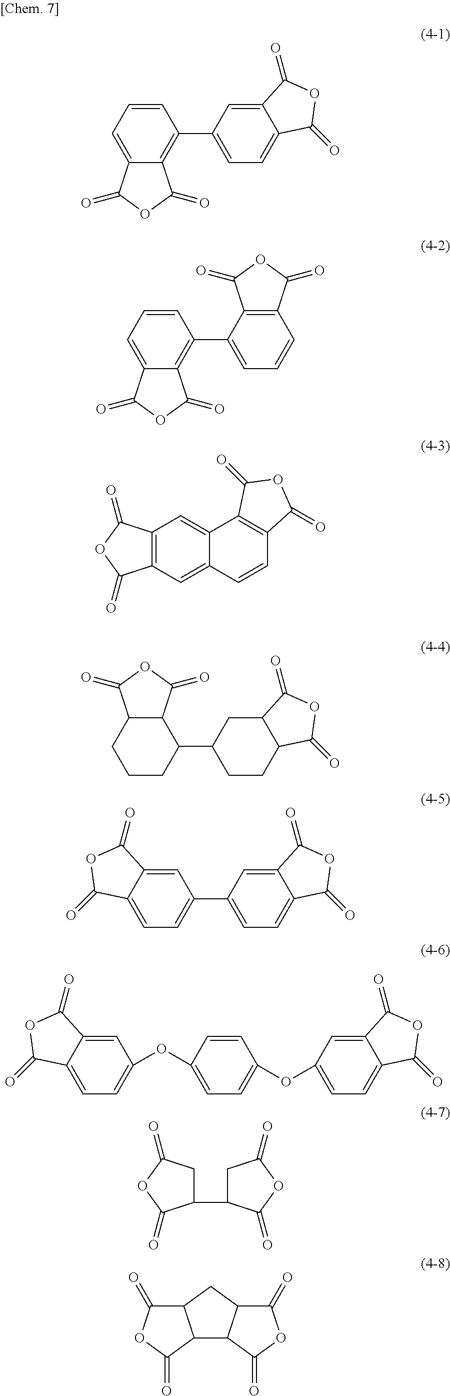

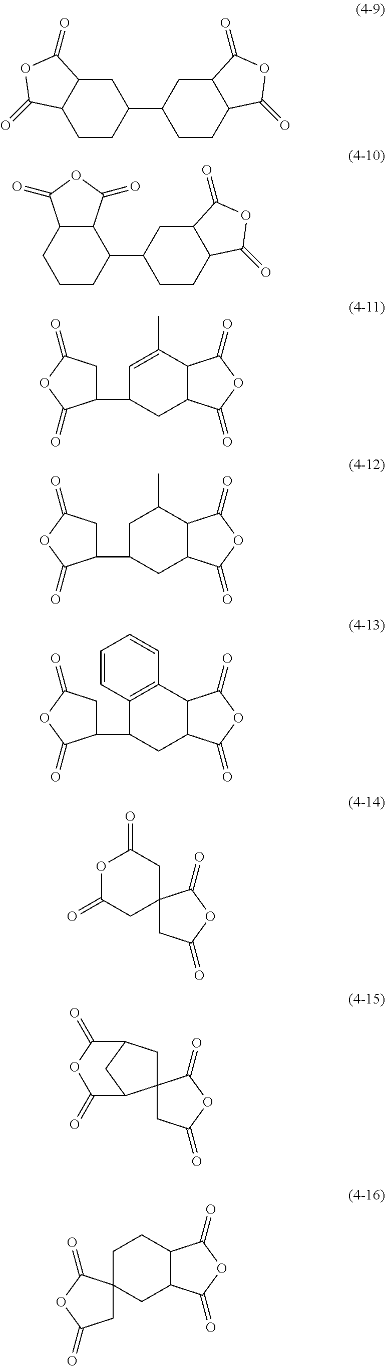

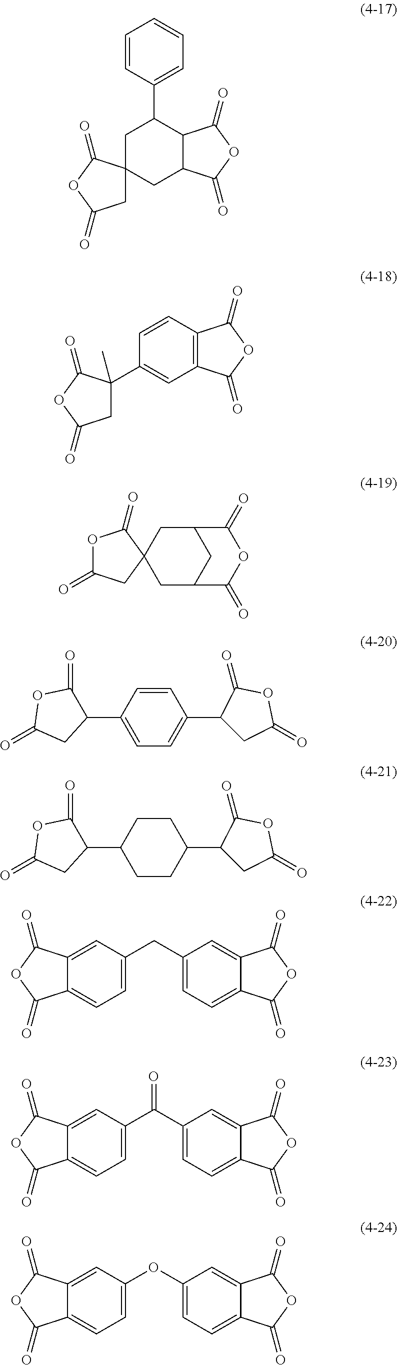

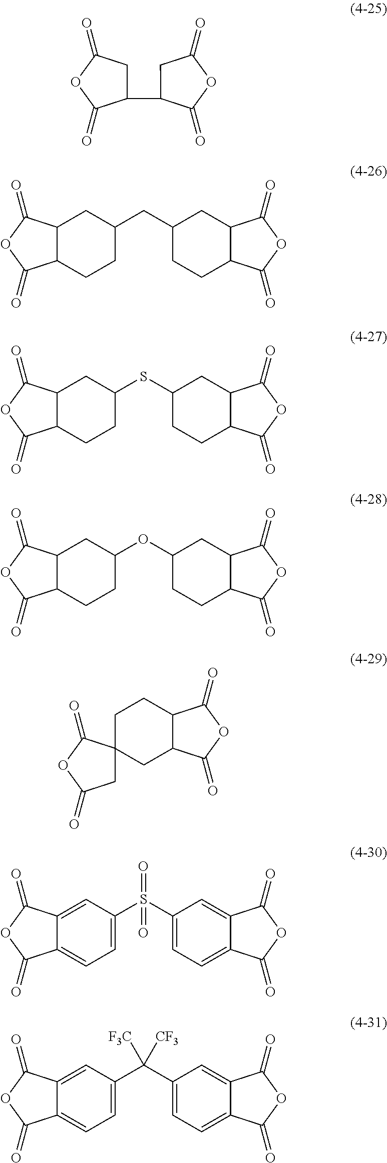

The tetracarboxylic dianhydride having a bent structure, which is represented by X in formula (6), is preferably at least one tetracarboxylic dianhydride selected from the group consisting of tetracarboxylic dianhydrides represented by the following chemical formulas (5-1) to (5-4).

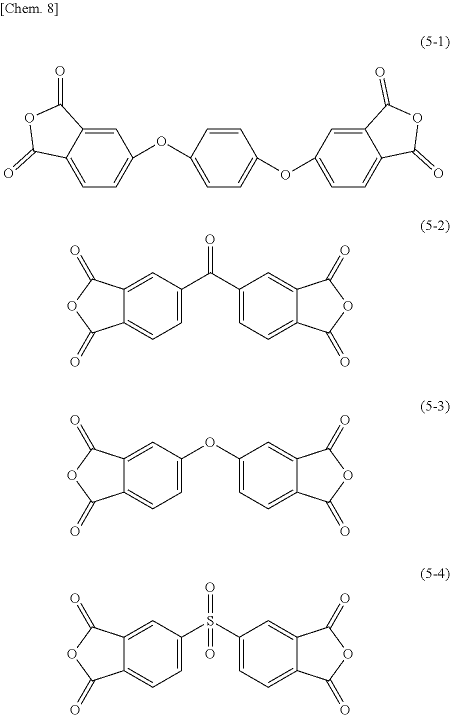 [SMILES: O=C1OC(=O)c2cc(Oc3ccc(Oc4ccc5c(c4)C(=O)OC5=O)cc3)ccc21 ; O=C(c1ccc2c(c1)C(=O)OC2=O)c1ccc2c(c1)C(=O)OC2=O ; O=C1OC(=O)c2cc(Oc3ccc4c(c3)C(=O)OC4=O)ccc21 ; O=C1OC(=O)c2cc(S(=O)(=O)c3ccc4c(c3)C(=O)OC4=O)ccc21]

In the tetracarboxylic dianhydride represented by the chemical formulas (5-1) to (5-4), a highly polar oxygen atom (O), a sulfur atom (S), or a carbonyl group (C═O) is bonded to a benzene ring to which an acid anhydride is bonded. The unpaired electron in the oxygen atom (O) or the sulfur atom (S) causes electronic bias, allowing charge interaction in the same molecule or with a diamine compound having an azobenzene group to readily occur, for example. Such charge interaction in the same polymer or between the polymers makes the polymer conformation more stable.

The diamine compound having an azobenzene group, which is represented by Y in the chemical formula (6), is preferably at least one diamine compound selected from the group consisting of diamine compounds represented by the following chemical formulas (9-1) to (9-5).

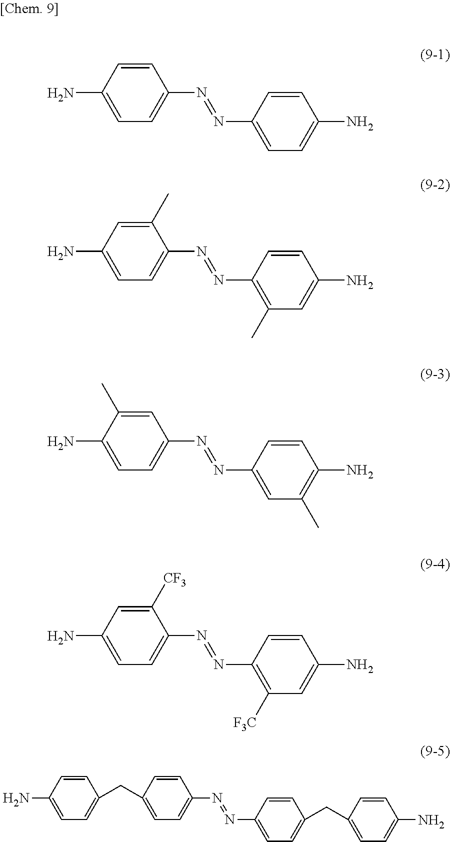 [SMILES: Nc1ccc(/N=N/c2ccc(N)cc2)cc1 ; Cc1cc(N)ccc1/N=N/c1ccc(N)cc1C ; Cc1cc(/N=N/c2ccc(N)c(C)c2)ccc1N ; Nc1ccc(/N=N/c2ccc(N)cc2C(F)(F)F)c(C(F)(F)F)c1 ; Nc1ccc(Cc2ccc(/N=N/c3ccc(Cc4ccc(N)cc4)cc3)cc2)cc1]

The polymer including the polyamic acid represented by the chemical formula (6) as a main chain undergoes photoisomerization reaction (cis-trans isomerization) when the azobenzene group in Y of the chemical formula (6) receives predetermined light (for example, linear polarized light (including ultraviolet light having a wavelength of 310 nm to 370 nm) and the azobenzene groups are aligned in one direction (direction not allowing absorption of the predetermined light) at the end.

As illustrated in FIG. 2, in this embodiment, the photo-alignment films 17a and 18a are disposed on the surfaces (opposing surfaces) of the substrates 17 and 18. The photo-alignment film may be disposed on only one of opposing surfaces of at least one of the substrates in some embodiments.

In a process of producing the photo-alignment film, first, a flowable alignment agent including a polyamic acid represented by the chemical formula (6) in an uncured state is applied to the surfaces (opposing surfaces) of the substrates 17 and 18 by using a coater. The applied agent is subjected to preliminary firing (for example, heated at 80° C. for two minutes) and then subjected to a photo-alignment process including irradiation with predetermined linear polarized light.

After the photo-alignment process, the applied agent is subjected to two separate steps of main firing. The main firing is performed to imidize the polymer chain (polyamic acid) in the photo-alignment film and to optimize the conformation of the polymer chain in the photo-alignment film, for example. The main firing includes a first firing process of firing the applied agent (coating film) at a first firing temperature after the photo-alignment process and a second firing process of firing the coating film at a second firing temperature higher than the first firing temperature after the first firing process. The first firing process optimizes the conformation of the polymer chain. The second firing process optimizes the imidization ratio.

In the first firing process, the applied agent that has been subjected to the photo-alignment process is heated at the first firing temperature (for example, 175° C.±10° C.) for a predetermined time (for example, 20 minutes). This optimizes the conformation of the polymer chain. Then, in the second firing step, the applied agent is heated at the second firing temperature (for example, 230° C.±10° C.), which is higher than the first firing temperature, for a predetermined time (for example, 20 minutes). This optimizes the imidization of the polymer chain. As a result, the applied alignment agent (coating film) becomes a photo-alignment film that allows the liquid crystal compound to align in a predetermined direction. When the applied agent is subjected to preliminary firing or main firing (first firing and second firing), some of the polyamic acids are suitably imidized.

The photo-alignment film according to the invention has a bent structure originating from the tetracarboxylic dianhydride in the polymer material. Thus, the photo-alignment film has a less linear polymer chain (than that without a bending structure). This allows the polymer chain arrangement in the photo-alignment film to be random, lowering the polymer chain density in the photo-alignment film. Thus, the photoisomerization reaction readily occurs at the azobenzene groups in the polymer chain and significantly reduces generation of radicals at the azobenzene groups in the polymer chain.

In addition, as described above, the main firing after the photo-alignment process includes two steps. This optimizes the steric relationship (conformation) of the polymer chains in the photo-alignment film and also optimizes the imidization ratio in the photo-alignment film.

(Sealant)

The sealant is disposed between the substrates 17 and 18 and surrounds the liquid crystal layer to seal the liquid crystal layer. The sealant bonds the substrates 17 and 18 to each other. The sealant has a frame-like shape surrounding the liquid crystal layer in plan view of the liquid crystal cell.

The sealant includes a cured resin composition containing a curable resin. The curable resin may be any curable resin having a UV reactive functional group and a thermal reactive functional group. When the curable resin composition is used as a sealant for a one-drop fill process, a curable resin having a methacryloyl group and/or an epoxy group is preferable due to its prompt curing reaction and high bonding properties. Examples of such a curable resin include methacrylate and epoxy resin. The resin may be used individually or in combination. In this specification, methacrylic may be acrylic or methacrylic.

Examples of the methacrylate include, but not limited to, urethane methacrylate having a urethane linkage and epoxy methacrylate derived from a compound having a glycidyl group and methacrylic acid.

Examples of the urethane methacrylate include, but are not limited to, derivatives obtained by reaction between diisocyanate, such as isophorone diisocyanate, and a reactive compound capable of addition reaction with isocyanate, such as acrylic acid and hydroxyethyl acrylate. The derivatives may be chain extended with caprolactone or polyol, for example. They are commercially available under trade names, e.g., U-122P, U-340P, U-4HA, and U-1084A (available from Shin-Nakamura Chemical Co., Ltd.), and KRM 7595, KRM 7610, and KRM 7619 (available from Daicel UCB Co., Ltd.).

Examples of the epoxy methacrylate include, but are not limited to, epoxy methacrylate derived from an epoxy resin, such as bisphenol A epoxy resin and propylene glycol diglycidyl ether, and methacrylic acid. They are commercially-available under trade names, e.g., EA-1020, EA-6320, and EA-5520 (available from Shin-Nakamura Chemical Co., Ltd.), and EPOXY ESTER 70PA and EPOXY ESTER 3002A (available from Kyoeisha Chemical Co., Ltd.).

Examples of methacrylates further include methyl methacrylate, tetrahydrofurfuryl methacrylate, benzyl methacrylate, isobornyl methacrylate, 2-hydroxyethyl methacrylate, glycidyl methacrylate, (poly)ethylene glycol dimethacrylate, 1,4-butanediol dimethacrylate, 1,6-hexanediol dimethacrylate, trimethylol propane triacrylate, pentaerythritol triacrylate, and glycerin dimethacrylate.

Examples of the epoxy resin include phenol novolac epoxy resin, cresol novolac epoxy resin, biphenyl novolac epoxy resin, trisphenol novolac epoxy resin, dicyclopentadiene novolac epoxy resin, bisphenol A epoxy resin, bisphenol F epoxy resin, 2,2′-diallylbisphenol A epoxy resin, bisphenol S epoxy resin, hydrogenated bisphenol A epoxy resin, propylene oxide added bisphenol A epoxy resin, biphenyl epoxy resin, naphthalene epoxy resin, resorcinol epoxy resin, and glycidyl amines.

The above-described epoxy resins are commercially available. For example, phenyl novolac epoxy resin is available under the trade name NC-3000S (from Nippon Kayaku Co., Ltd.), trisphenol novolac epoxy resin is available under the trade name EPPN-501H or EPPN-501H (from Nippon Kayaku Co., Ltd.), dicyclopentadiene novolac epoxy resin is available under the trade name NC-7000L (from Nippon Kayaku Co., Ltd.), bisphenol A epoxy resin is available under the trade name EPICLON 840S or EPICLON 850CRP (from Dainippon Ink and Chemicals Inc.), bisphenol F epoxy resin is available under the trade name EPICOAT 807 (from Japan Epoxy Resin Co., Ltd.) and EPICLON 830 (from Dainippon Ink and Chemicals Inc.), 2,2′-diallyl bisphenol A epoxy resin is available under the trade name RE310NM (from Nippon Kayaku Co., Ltd.), hydrogenated bisphenol epoxy resin is available under the trade name EPICLON 7015 (from Dainippon Ink and Chemicals Inc.), propylene oxide added bisphenol A epoxy resin is available under the trade name epoxy ester 3002A (from Kyoeisha Chemical Co., Ltd.), biphenyl epoxy resin is available under the trade name EPICOAT YX-4000H or YL-6121H (from Japan Epoxy Resin Co., Ltd.), naphthalene epoxy resin is available under the trade name EPICLON HP-4032 (from Dainippon Ink and Chemicals Inc.), resorcinol epoxy resin is available under the trade name DENACOL EX-201 (from Nagase Chemtex Corporation), glycidyl amine is available under the trade name EPICLON 430 (from Dainippon Ink and Chemicals Inc.) or EPICOAT 630 (from Japan Epoxy Resin Co., Ltd.).

The above-descried curable resin composition may suitably include an epoxy/methacrylic resin including at least one methacrylic group and at least one epoxy group in one molecule as a curable resin. Examples of the epoxy/methacrylic resin include a compound obtained by reacting a part of the epoxy group of the epoxy resin with methacrylic acid in the presence of a basic catalyst according to a common procedure, a compound obtained by reacting 1 mole of bi- or higher functional isocyanate with ½ mole of methacrylic monomer having a hydroxyl group and subsequently with ½ mole of glycidol, and a compound obtained by reacting methacrylate having an isocyanate group with glycidol. The epoxy/methacrylic resin is commercially available under the trade name UVAC1561 (from Daicel UCB Co.), for example.

The curable resin composition includes a photopolymerization initiator. The polymerization initiator may be any photopolymerization initiator that allows the curable resin to be polymerized by UV irradiation.

The photopolymerization initiator is commercially available under the trade name “Irgacure 651”, “Irgacure 189”, or “Irgacure-OXE01” (from BASF Japan), for example.

The curable resin composition includes a thermosetting agent. The thermosetting agent allows the thermal reactive functional group in the curable resin to be reacted by heat for cross-linking and improves adhesiveness and moisture-resistance of the cured resin composition. The thermosetting agent is not particularly limited, but a thermosetting agent including a low-temperature reactive amine and/or thiol group is preferable, because the curable resin composition according to the invention is cured at a curing temperature of 100 to 120° C. when used as a sealant for a one-drop fill process. Examples of the thermosetting agent include, but are not limited to, a hydrazide compound, such as
1,3-bis[hydrazinocarbonoethyl-5-isopropylhydantoin] and adipic acid dihydrazide, dicyandiamide, a guanidine derivative,
1-cyanoethyl-2-phenylimidazole,
N-[2-(2-methyl-1-imidazolyl)ethyl]urea,
2,4-diamino-6-[2′-methylimidazolyl-(1′)]-ethyl-s-triazine,
N,N′-bis(2-methyl-1-imidazolylethyl)urea,
N,N′-(2-methyl-1-imidazolylethyl)-adipamide,
2-phenyl-4-methyl-5-hydroxymethylimidazole,
2-imidazoline-2-thiol, 2,2′-thiodiethanethiol, and an addition product of an amine and an epoxy resin. These materials may be used individually or in combination.

(Liquid Crystal Layer)

The liquid crystal layer includes a first liquid crystal compound and a second liquid crystal compound described below as liquid crystal compounds (liquid crystal molecules).

The first liquid crystal compound is a liquid crystal compound having an unsaturated bond such as an alkenyl group, for example, and is at least one compound selected from the group consisting of compounds having an alkenyl group and represented by the following chemical formulas (3-1) to (3-4).

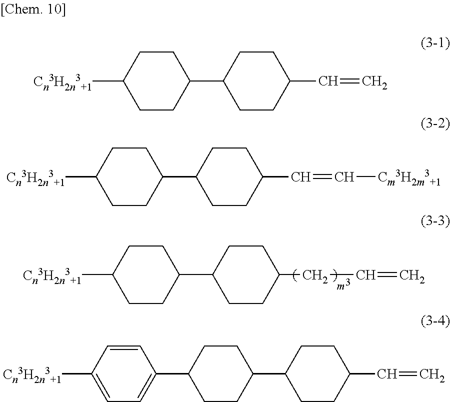

In the formulas, n³ and m³ are identical or different integers and each an integer of 1 to 6.

The second liquid crystal compound is a compound having at least one structure selected from the group consisting of structures represented by the following chemical formulas (1-1) and (1-2).

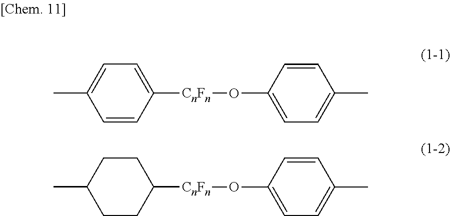

In the formulas n is an integer of 1 to 3.

The second liquid crystal compound having the structure (skeleton) represented by formula (1-1) or (1-2) allows the liquid crystal material as a whole to have positive dielectric anisotropy. Furthermore, in the structure (skeleton) represented by formula (1-1) or (1-2), two fluorine atoms (F) and one oxygen atom (O) are bonded to a carbon atom (C) that bonds aromatic rings or bonds an aliphatic ring with an aromatic ring. This increases electron nucleophilicities, enhancing the bond between the aromatic rings or between the aliphatic ring and the aromatic ring. The second liquid crystal compound having the structure (skeleton) represented by the chemical formula (1-1) or (1-2) contributes to improvement in T_{NI}.

Furthermore, the second liquid crystal compound may be at least one compound selected from the group consisting of compounds represented by the following chemical formulas (2-1) to (2-8).

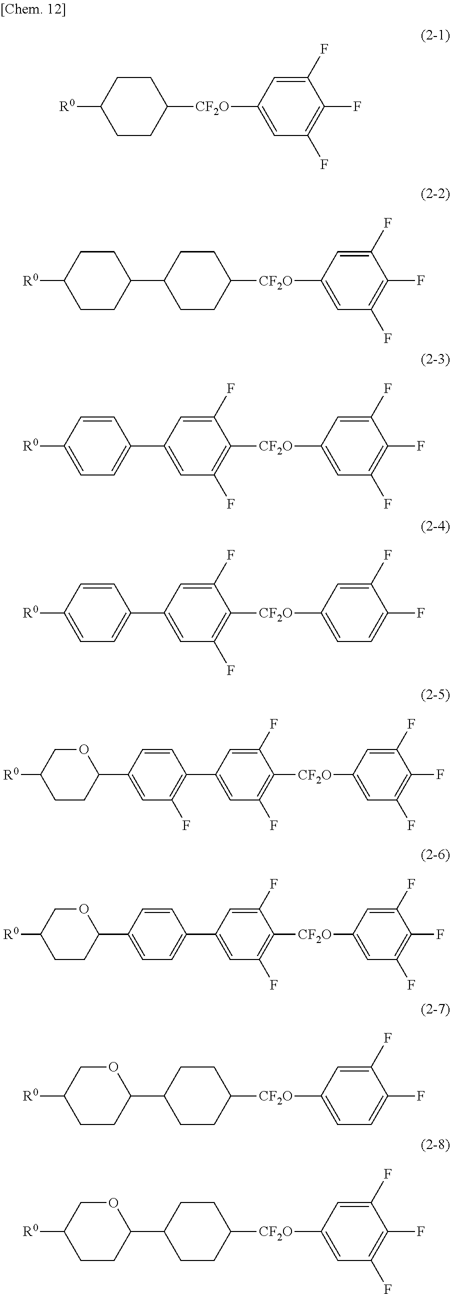

In the formulas, R⁰ is a saturated alkyl group having 1 to 12 carbon atom(s).

The liquid crystal compound having positive dielectric anisotropy is used in a horizontal alignment mode or a twisted nematic (TN) mode, for example. In the horizontal alignment mode, the liquid crystal compounds having positive dielectric anisotropy are horizontally aligned with respect to the surface of the substrate. Specific examples of the horizontal alignment mode include In-Plane Switching (IPS) mode and Fringe Field Switching (FFS) mode. In IPS mode, a horizontal electric field is applied to the liquid crystal layer. In TN mode, the liquid crystal compound having positive dielectric anisotropy is twisted by 90° when viewed in the normal direction with respect to the substrate.

The liquid crystal material of the liquid crystal layer (first and second liquid crystal compounds) has a nematic-isotropic phase transition temperature (T_{NI}) (° C.) of 90° C. or more. The liquid crystal material of the liquid crystal layer (first and second liquid crystal compounds) having T_{NI} of 90° C. or more reduces a decrease in viscosity (flowability) of the liquid crystal layer when the temperature of the liquid crystal cell (liquid crystal panel) is increased by the light from the backlight, for example. Thus, if a radical is generated in a polyamic acid included in the photo-alignment film, the radical is unlikely to transfer to the liquid crystal compound (first liquid crystal compound) having an unsaturated bond such as an alkenyl group.

Thermal behavior of the liquid crystal material is analyzed by using a thermal property measurement device, such as a differential scanning calorimeter (DSC) (available from METTLER TOLEDO), for example, to determine T_{NI} of the liquid crystal material (first and second liquid crystal compounds).

In the liquid crystal material (first and second liquid crystal compounds) of the liquid crystal layer, the content (% by weight) of the second liquid crystal compound is preferably 3 to 40%, and more preferably 5 to 15%. The content (% by weight) of the second liquid crystal compound in this range readily allows T_{NI} of the liquid crystal layer (the liquid crystal material including the first and second liquid crystal compounds) to be 90° C. or more.

The liquid crystal cell may employ any liquid crystal alignment mode (display mode) without departing from the scope of the invention. Examples of the liquid crystal alignment modes include TN mode, IPS mode, and FFS mode.

### EXAMPLES

Hereinafter, the invention is described further in detail with reference to Examples, but the invention is not limited to Examples.

### Practical Example 1

### Production of Liquid Crystal Cell

An array substrate for FFS mode that has TFTs and pixel electrodes, for example, on a glass substrate and a counter substrate (not having an electrode) for FFS mode that has a color filter, for example, on a glass substrate were provided. An alignment agent for horizontal alignment including a polyamic acid represented by the following chemical formula (10) was applied to a surface of each of the array substrate and the counter substrate by a spin coating method. The applied agent was heated at 80° C. for two minutes in a preliminary firing process, and then the applied agent was irradiated with linear polarized light (including ultraviolet light having a wavelength of 310 nm to 370 nm) from a predetermined direction at 2 J/cm² in a photo-alignment process. Then, after the photo-alignment process, the applied agent was subjected to two separate steps of a main firing process. Specifically described, the applied agent was heated at 175° C. for 20 minutes in the first firing step and then the applied agent was heated at 230° C. for 20 minutes in the second firing step. A photo-alignment film was formed on a surface of each of the array substrate and the counter substrate by the main firing process.

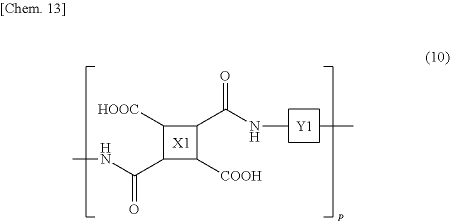

In the formula (10), P is a natural number. As the tetracarboxylic dianhydride, which is represented by X1 in formula (10), a tetracarboxylic dianhydride having a bent structure represented by the following chemical formula (11) was used.

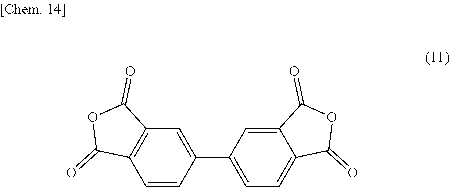 [SMILES: O=C1OC(=O)c2cc(-c3ccc4c(c3)C(=O)OC4=O)ccc21]

As the diamine compound having an azobenzene group and represented by Y1 in formula (10), a diamine compound represented by the following chemical formula (12) was used.

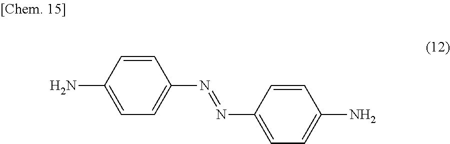 [SMILES: Nc1ccc(/N=N/c2ccc(N)cc2)cc1]

Then, an ODF sealant (trade name: “Photolec”, available from SEKISUI CHEMICAL CO., LTD.) in an uncured state was applied in a frame-like shape by using a dispenser on the photo-alignment film of the array substrate. The ODF sealant in an uncured state is ultraviolet curable and thermal curable and includes a mixed composition including a photopolymerization initiator, a methacrylic monomer, which are used in photopolymerization (radical polymerization), and an epoxy monomer, and an amine curing agent, which are used in thermal polymerization.

Then, the liquid crystal material was drop added to predetermined positions of the photo-alignment film on the counter substrate. The liquid crystal material includes the first liquid crystal compound having an unsaturated bond and the second liquid crystal compound including at least one compound selected from the group consisting of compounds having positive dielectric anisotropy and represented by the above chemical formulas (2-1) to (2-8). The content of the second liquid crystal compound in the liquid crystal material was 5% by weight.

The first liquid crystal compound was suitably selected from liquid crystal compounds having an alkenyl group and represented by the chemical formulas (3-1) to (3-4) in this specification such that the liquid crystal material as a whole has T_{NI} (nematic-isotropic phase transition temperature) of 92° C.

Then, the array substrate and the counter substrate were bonded to each other under vacuum to form a laminate. The sealant of the laminate was irradiated with ultraviolet light (including ultraviolet light of 340 nm to 450 nm) to cure the sealant with light. Furthermore, the laminate was heated at 130° C. for 40 minutes to thermally cure the sealant to seal the liquid crystal material and re-alignment treatment was performed to give an isotropic phase to the liquid crystal. Then, the laminate was cooled to a room temperature. Thus, an FFS-mode liquid crystal cell was obtained.

### Comparative Example 1

A liquid crystal cell of Comparative Example 1 was produced in the same way as that of Practical Example 1, except that an alignment agent for horizontal alignment including a polyamic acid represented by the following chemical formula (13) was used to form photo-alignment films.

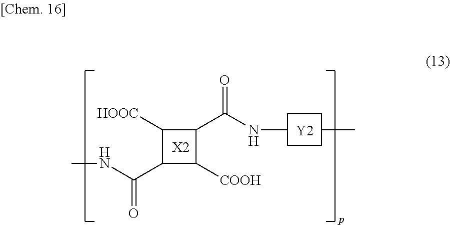

In formula (13), P is a natural number. As the tetracarboxylic dianhydride represented by X2 in formula (13), a tetracarboxylic dianhydride having a linear structure represented by the following chemical formula (14) was used.

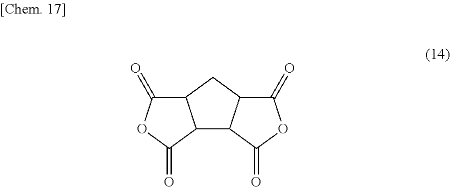 [SMILES: O=C1OC(=O)C2C1CC1C(=O)OC(=O)C12]

As the diamine compound having an azobenzene group and represented by Y1 in formula (13), the diamine compound represented by the above chemical formula (12) was used as in Practical Example 1.

### Comparative Example 2

A liquid crystal cell of Comparative Example 2 was produced in the same way as that of Practical Example 1, except that the main firing process includes a first firing step (at 120° C. for 20 minutes) and a second firing step (at 200° C. for 20 minutes).

### Comparative Example 3

A liquid crystal cell of Comparative Example 3 was produced in the same way as that of Practical Example 1, except that the first liquid crystal compound was suitably selected from liquid crystal compounds having an alkenyl group and represented by the chemical formulas (3-1) to (3-4) in this specification such that the liquid crystal material as a whole had T_{NI} (nematic-isotropic phase transition temperature) of 75° C. The content of the second liquid crystal compound in the liquid crystal material was 3% by weight.

### Comparative Example 4

A liquid crystal cell of Comparative Example 4 was produced in the same way as that of Practical Example 1, except the following: the first liquid crystal compound was suitably selected from liquid crystal compounds having an alkenyl group and represented by the chemical formulas (3-1) to (3-4) in this specification such that the liquid crystal material as a whole had T_{NI} (nematic-isotropic phase transition temperature) of 75° C.; and a liquid crystal compound having negative dielectric anisotropy and represented by the following chemical formula (15) was employed instead of the second liquid crystal compound.

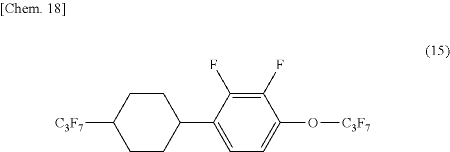

Response Properties

The liquid crystal cells of Practical Example 1 and Comparative Examples 1 to 4 were evaluated in terms of response properties. Specifically described, using “Photal 5200” (available from Otsuka Electronics Co., Ltd.), the time required for a change in transmittance from 10% to 90% when the voltage applied to the liquid crystal cell was raised from 0.5 V to 6 V was measured as response rise time κr (ms). In addition, the time required for a change in transmittance from 90% to 10% when the voltage applied to the liquid crystal cell was lowered from 6 V to 0.5 V was measured as response fall time κd (ms). The response properties of each of the liquid crystal cells were indicated by κr+κd (ms). The results are shown in Table 1.

Contrast

Contrast of each of the liquid crystal cells of Practical Example 1 and Comparative Examples 1 to 4 was determined using “SR-1” (available from TOPCON CORPORATION). The results are shown in Table 1.

High-Temperature and High-Humidity Test

A high-temperature and high-humidity test described below was performed on the liquid crystal cells of Practical Example 1 and Comparative Examples 1 to 4. The liquid crystal cell on a backlight device in a turned-on state was left untouched for 1000 hours in an oven at a temperature of 90° C., and a voltage holding rate (VHR) of the liquid crystal cell was determined before and after the liquid crystal cell was left (at the start of the test and 1000 hours after the start of the test). The voltage holding rate was measured using 6254 VHR measurement system (available from TOYO Corporation) at 1 V and 70° C. The results are shown in Table 1.

TABLE 1

| | RESPONSE | | | |
|---|---|---|---|---|
| | PROPERTIES | | VHR (%) | |
| | (τr + τd) | | START | 1000 hrs |
| | (ms) | CONTRAST | (0 hr) | LATER |
| PRACTICAL | 18 | 1500 | 99.5 | 99.1 |
| EXAMPLE 1 | | | | |
| COMPARATIVE | 18 | 1200 | 98.8 | 97.2 |
| EXAMPLE 1 | | | | |
| COMPARATIVE | 18 | 1400 | 99.5 | 97.6 |
| EXAMPLE 2 | | | | |
| COMPARATIVE | 16 | 1500 | 99.5 | 95.7 |
| EXAMPLE 3 | | | | |
| COMPARATIVE | 28 | 1600 | 98.1 | 88.5 |
| EXAMPLE 4 | | | | |

In Practical Example 1, the polymer material of the photo-alignment film had a bent structure originating from the tetracarboxylic dianhydride, and thus linearity of the polymer chain in the photo-alignment film was low (compared with that without a bent structure). This allowed the polymer chain arrangement in the photo-alignment film to be random, enabling the polymer chain density in the photo-alignment film to be low. This probably allowed the photoisomerization reaction to readily occur at the azobenzene group in the polymer chain and further largely reduced generation of a radical at the azobenzene group in the polymer chain. In Practical Example 1, the response properties, the contrast, and VHR were all good.

Contrary to this, it was confirmed that the contrast and VHR (0 hour and 1000 hours later) were lower than those in Practical Example 1. In Comparative Example 1, the linearity of the polymer material of the photo-alignment film was higher than that in Practical Example 1. This probably allowed radicals to be generated in the photo-alignment process (polarized UV irradiation) simultaneously with the photoisomerization reaction, leading to a reduction in the alignment stability and a decrease in VHR. The reduction in VHR was possibly caused by transfer of the radicals generated at the azobenzene groups in the photo-alignment film to the liquid crystal compound having alkenyl groups in the liquid crystal material.

It was confirmed that, in Comparative Example 2, contrast was slightly lower and VHR (1000 hours later) was lower than those in Practical Example 1. In Comparative Example 2, the heating temperatures at the first firing step and the second firing step, which are included in the main firing process of the photo-alignment film, were lower than those in Practical Example 1. Thus, in Comparative Example 2, the conformation and the imidization ratio of the polymer material (polymer chain) of the photo-alignment film were poor compared with those in Practical Example 1. The imidization ratio of the polymer material constituting the photo-alignment film is affected by the hardness of the photo-alignment film.

In Comparative Example 3, the response properties and the contrast were substantially the same as those in Practical Example 1, but VHR after 1000 hours under the high-temperature and high-humidity condition was largely lower than that in Practical Example 1. The liquid crystal material in Comparative Example 3 has a low T_{NI} (75° C.). This probably allowed the viscosity of the liquid crystal material to decrease at a temperature (π° C.), which is higher than T_{NI} (75° C.) allowing a few radicals that were generated in the azobenzene groups in the photo-alignment film to efficiently transfer to the liquid crystal compound having the alkenyl groups.

In Comparative Example 4, the value of contrast was high, but the response properties and VHR (0 hour and 1000 hours later) were not good. A negative liquid crystal material has a high viscosity even if containing a liquid crystal compound having an alkenyl group and thus typically has a low T_{NI}. Thus, in Comparative Example 4, a few radials generated in the azobenzene groups in the photo-alignment film were possibly efficiently transferred to the liquid crystal compound having the alkenyl groups.

### Practical Example 2

A liquid crystal cell of Practical Example 2 was produced in the same way as that of Practical Example 1, except that a tetracarboxylic dianhydride having a bent structure represented by the following chemical formula (16) was used as the tetracarboxylic dianhydride represented by X1 in the polyamic acid represented by the chemical formula (10) employed in Practical Example 1.

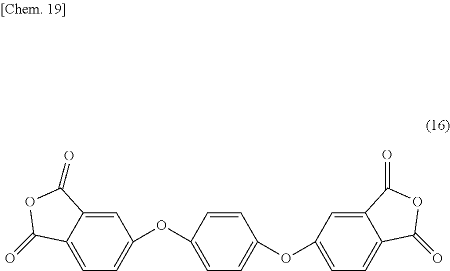 [SMILES: O=C1OC(=O)c2cc(Oc3ccc(Oc4ccc5c(c4)C(=O)OC5=O)cc3)ccc21]

### Practical Example 3

A liquid crystal cell of Practical Example 3 was produced in the same way as that of Practical Example 1, except that a tetracarboxylic dianhydride having a bent structure represented by the following chemical formula (17) was used as the tetracarboxylic dianhydride represented by X1 in the polyamic acid, which is represented by the chemical formula (10) employed in Practical Example 1.

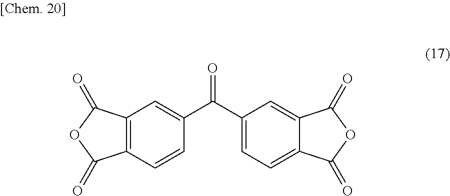 [SMILES: O=C(c1ccc2c(c1)C(=O)OC2=O)c1ccc2c(c1)C(=O)OC2=O]

### Practical Example 4

A liquid crystal cell of Practical Example 4 was produced in the same way as that of Practical Example 1, except that a tetracarboxylic dianhydride having a bent structure represented by the following chemical formula (18) was used as the tetracarboxylic dianhydride represented by X1 in the polyamic acid, which is represented by the chemical formula (10) employed in Practical Example 1.

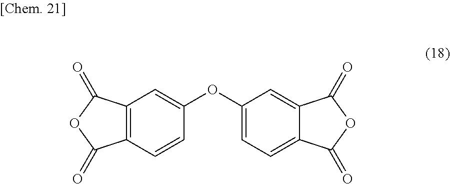 [SMILES: O=C1OC(=O)c2cc(Oc3ccc4c(c3)C(=O)OC4=O)ccc21]

### Practical Example 5

A liquid crystal cell of Practical Example 5 was produced in the same way as that of Practical Example 1, except that a tetracarboxylic dianhydride having a bent structure represented by the following chemical formula (19) was used as the tetracarboxylic dianhydride providing X1 in the polyamic acid, which is represented by the chemical formula (10) used in Practical Example 1.

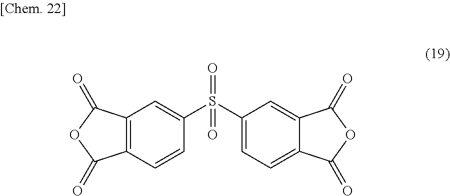 [SMILES: O=C1OC(=O)c2cc(S(=O)(=O)c3ccc4c(c3)C(=O)OC4=O)ccc21]

The liquid crystal cells of Practical Examples 2 to 5 were evaluated in terms of response properties, contrast, and VHR (high-temperature and high-humidity test) in the same way as those in Practical Example 1. The results are shown in Table 2.

TABLE 2

| | RESPONSE | | | |
|---|---|---|---|---|
| | PROPERTIES | | VHR (%) | |
| | (τr + τd) | | START | 1000 hrs |
| | (ms) | CONTRAST | (0 hr) | LATER |
| PRACTICAL | 18 | 1500 | 99.5 | 99.1 |
| EXAMPLE 2 | | | | |
| PRACTICAL | 18 | 1500 | 99.5 | 99.3 |
| EXAMPLE 3 | | | | |
| PRACTICAL | 18 | 1500 | 99.5 | 99.0 |
| EXAMPLE 4 | | | | |
| PRACTICAL | 18 | 1500 | 99.5 | 99.3 |
| EXAMPLE 5 | | | | |

As indicated in Table 2, response properties, contrast, and VHR (0 hour and 1000 hours later) were high in all of Practical Examples 2 to 5. This is probably because that the polymer of the photo-alignment film has a bent structure that originates from the tetracarboxylic dianhydride and also includes an oxygen atom and a sulfur atom that originate from the tetracarboxylic dianhydride and can cause charge interaction.

### Practical Example 6

A liquid crystal cell of Practical Example 6 was produced in the same way as that of Practical Example 1, except that the first liquid crystal compound was suitably selected from liquid crystal compounds having an alkenyl group and represented by the chemical formulas (3-1) to (3-1) such that the liquid crystal material (first and second liquid crystal compounds) as a whole had T_{NI} (nematic-isotropic phase transition temperature) of 90° C. The content of the second liquid crystal compound in the liquid crystal material was 10% by weight.

### Practical Example 7

A liquid crystal cell of Practical Example 7 was produced in the same way as that of Practical Example 1, except that the first liquid crystal compound was suitably selected from liquid crystal compounds having an alkenyl group and represented by the chemical formulas (3-1) to (3-4) such that the liquid crystal material (first and second liquid crystal compounds) as a whole had T_{NI} (nematic-isotropic phase transition temperature) of 95° C. The content of the second liquid crystal compound in the liquid crystal material was 12% by weight.

### Practical Example 8

A liquid crystal cell of Practical Example 8 was produced in the same way as that of Practical Example 1, except that the first liquid crystal compound was suitably selected from liquid crystal compounds having an alkenyl group and represented by the chemical formulas (3-1) to (3-4) such that the liquid crystal material (first and second liquid crystal compounds) as a whole had T_{NI} (nematic-isotropic phase transition temperature) of 97° C. The content of the second liquid crystal compound in the liquid crystal material was 13% by weight.

### Practical Example 9

A liquid crystal cell of Practical Example 9 was produced in the same way as that of Practical Example 1, except that the first liquid crystal compound was suitably selected from liquid crystal compounds having an alkenyl group and represented by the chemical formulas (3-1) to (3-4) such that the liquid crystal material (first and second liquid crystal compounds) as a whole had T_{NI} (nematic-isotropic phase transition temperature) of 100° C. The content of the second liquid crystal compound in the liquid crystal material was 15% by weight.

The liquid crystal cells of Practical Examples 6 to 9 were evaluated in terms of response properties, contrast, and VHR (high-temperature and high-humidity test) in the same way as that of Practical Example 1. The results are shown in Table 3.

TABLE 3

| | | RESPONSE | | VHR (%) | |
|---|---|---|---|---|---|
| | | PROPERTIES | | | 1000 |
| | T_{NI} | (τr + τd) | | START | hrs |
| | (° C.) | (ms) | CONTRAST | (0 hr) | LATER |
| PRACTICAL | 90 | 17 | 1500 | 99.5 | 99.0 |
| EXAMPLE 6 | | | | | |
| PRACTICAL | 95 | 19 | 1500 | 99.5 | 99.2 |
| EXAMPLE 7 | | | | | |
| PRACTICAL | 97 | 19 | 1550 | 99.5 | 99.2 |
| EXAMPLE 8 | | | | | |
| PRACTICAL | 100 | 21 | 1600 | 99.5 | 99.3 |
| EXAMPLE 9 | | | | | |

As indicated in Table 3, since the viscosity of the liquid crystal material increases as T_{NI} increases, it was confirmed that the response properties indicated by (κr+κd) (ms) slightly increased as T_{NI} increased. The contrast increased as T_{NI} increased, which is a good result. Furthermore, VHR determined 1000 hours later also increased as T_{NI} increased, which is a good result. This is probably because that, since the viscosity of the liquid crystal material increased as T_{NI} increased, most of the radicals generated in the photo-alignment film were not transferred to the alkenyl groups in the liquid crystal.

### EXPLANATION OF SYMBOLS

10 . . . liquid crystal display device, 11 . . . liquid crystal panel, 12 . . . backlight, 13 . . . housing, 14 . . . liquid crystal cell, 15, 16 . . . polarizing plate, 17 . . . substrate (array substrate), 17a . . . photo-alignment film, 18 . . . substrate (counter substrate), 18a . . . photo-alignment film, 19 . . . liquid crystal layer, 20 . . . sealant

1. A liquid crystal cell comprising two substrates facing each other and a liquid crystal layer between the substrates, the substrates having a photo-alignment film on at least one of opposing surfaces of the substrates, wherein
the photo-alignment film includes a polymer having a polyamic acid as a main chain, the polyamic acid being obtained through polymerization of a tetracarboxylic dianhydride having a bent structure and a diamine compound having an azobenzene group, and
the liquid crystal layer includes a first liquid crystal compound having an unsaturated bond and a second liquid crystal compound having at least one structure selected from the group consisting of structures represented by the following chemical formulas (1-1) and (1-2) and has a nematic-isotropic phase transition temperature of 90° C. or more. 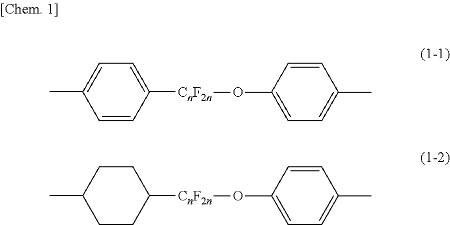
in which n is an integer of 1 to 3.

2. The liquid crystal cell according to claim 1, wherein the second liquid crystal compound is at least one compound selected from the group consisting of compounds represented by the following chemical formulas (2-1) to (2-8). 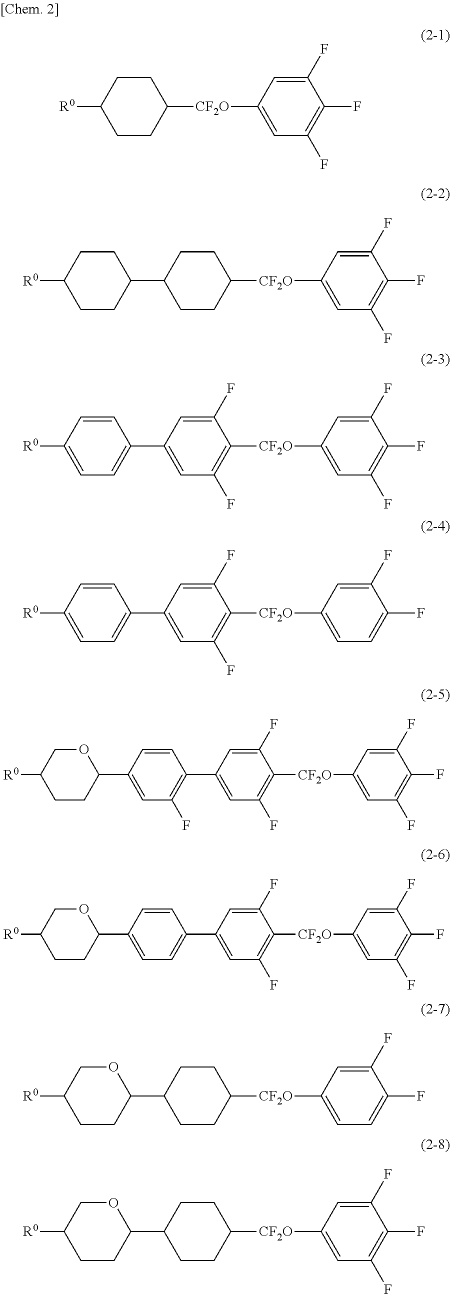
in which R⁰ is an unsaturated alkyl group having 1 to 12 carbon atom(s).

3. The liquid crystal cell according to claim 1, wherein the first liquid crystal compound is at least one compound selected from the group consisting of compounds having an alkenyl group and represented by the following chemical formulas (3-1) to (3-4). 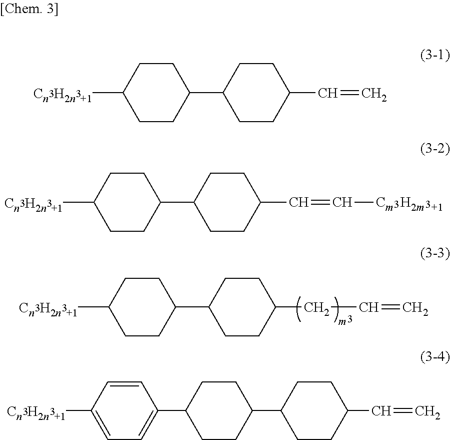
in which n³ and m³ are identical or different integers and are each an integer of 1 to 6.

4. The liquid crystal cell according to claim 1, wherein the tetracarboxylic dianhydride is at least one tetracarboxylic dianhydride selected from the group consisting of tetracarboxylic dianhydrides represented by the following chemical formulas (4-1) to (4-31).

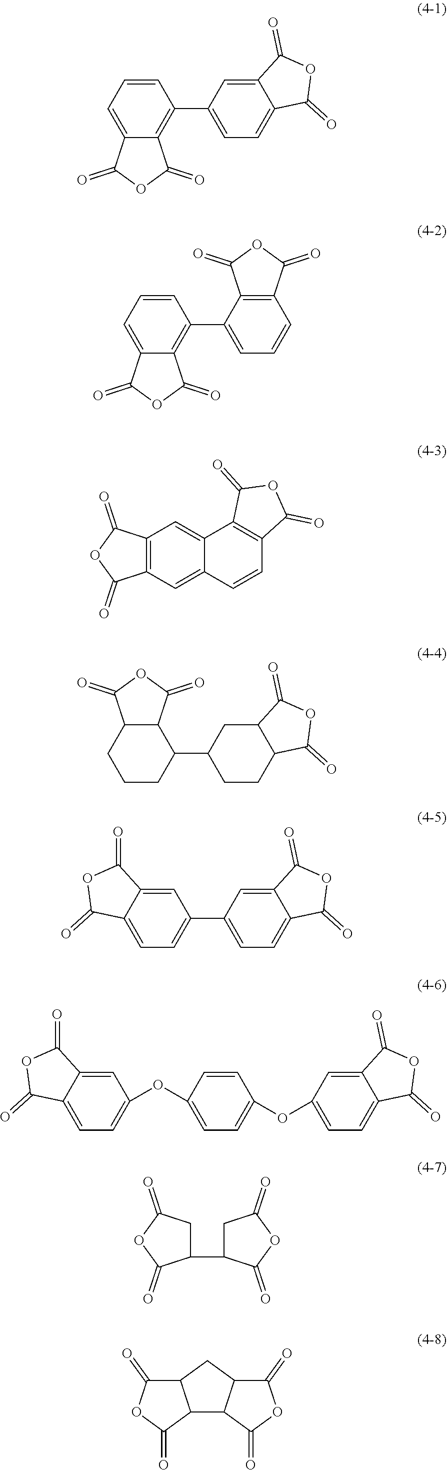

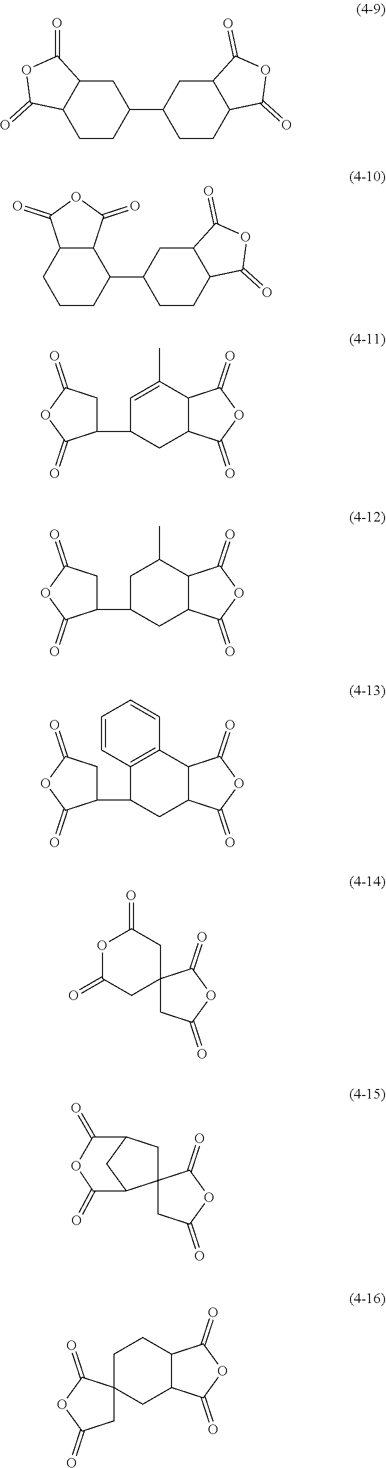

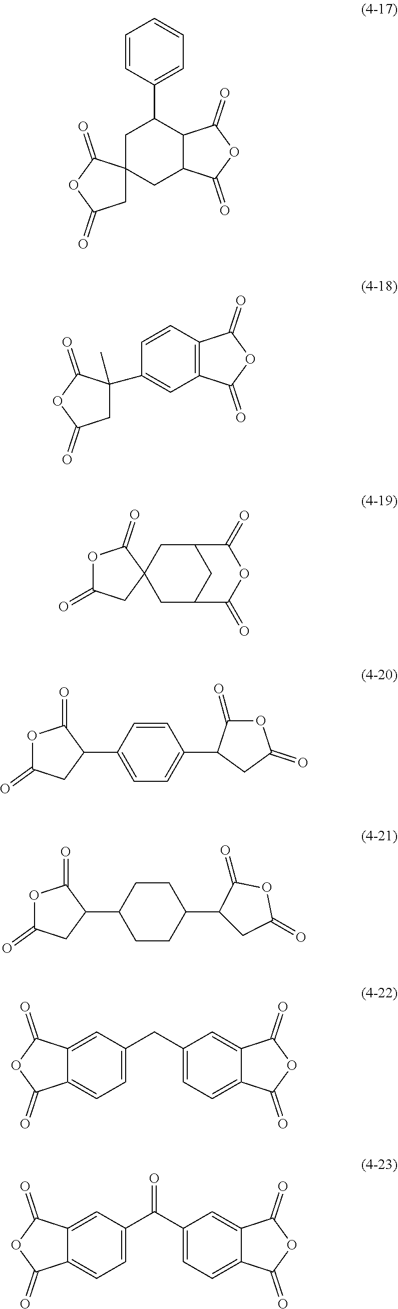

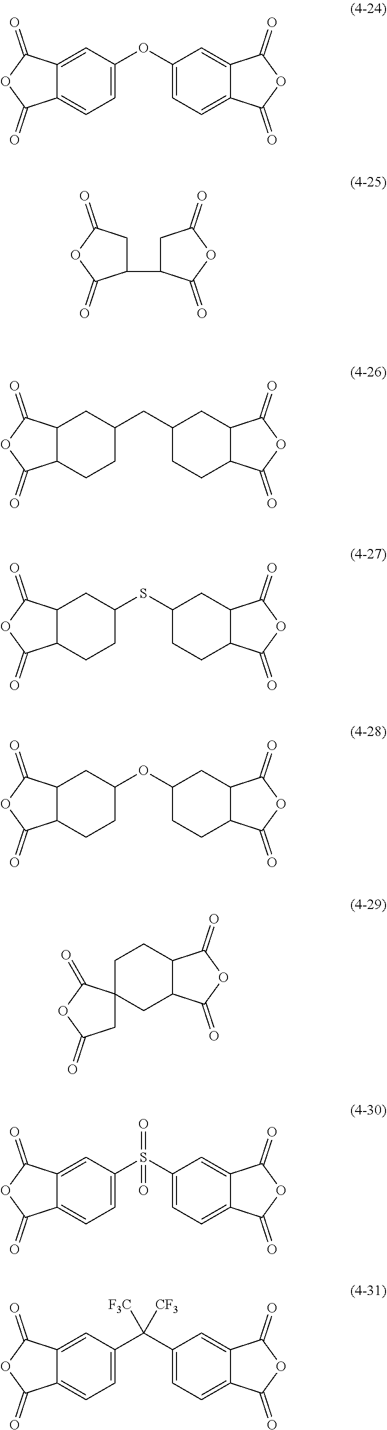

5. The liquid crystal cell according to claim 1, wherein the tetracarboxylic dianhydride is at least one tetracarboxylic dianhydride selected from the group consisting of tetracarboxylic dianhydrides represented by the following chemical formulas (5-1) to (5-4).

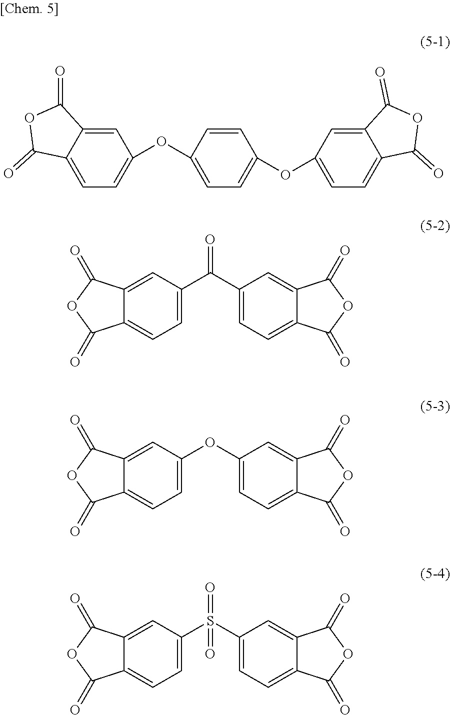 [SMILES: O=C1OC(=O)c2cc(Oc3ccc(Oc4ccc5c(c4)C(=O)OC5=O)cc3)ccc21 ; O=C(c1ccc2c(c1)C(=O)OC2=O)c1ccc2c(c1)C(=O)OC2=O ; O=C1OC(=O)c2cc(Oc3ccc4c(c3)C(=O)OC4=O)ccc21 ; O=C1OC(=O)c2cc(S(=O)(=O)c3ccc4c(c3)C(=O)OC4=O)ccc21]

6. A liquid crystal display device comprising:
a liquid crystal panel including the liquid crystal cell according to claim 1; and
a backlight configured to supply light to the liquid crystal panel.

7. A method of producing the liquid crystal cell according to claim 1, the method comprising:
a coating film formation process of applying a photo-alignment agent composition including the polymer onto at least one of the opposing surfaces of the substrates to form a coating film formed of the photo-alignment agent composition on the at least one of the opposing surfaces;
a photo-alignment process of applying predetermined light to the coating film such that the azobenzene group in the polymer is oriented in a predetermined direction;
a first firing process of firing the coating film at a first firing temperature after the photo-alignment process; and
a second firing process of firing the coating film at a second firing temperature higher than the first firing temperature after the first firing process.

8. The method of producing the liquid crystal cell according to claim 7, wherein the first firing temperature at the first firing process is 175±10° C., and
the second firing temperature at the second firing process is 230±10° C.
